(19) United States
(12) Patent Application Publication
(10) Pub. No.: US 2024/0292091 A1
(43) Pub. Date: Aug. 29, 2024

(54) AUTOMATIC GROUPING IN MACHINE VISION SYSTEMS

(71) Applicant: ZEBRA TECHNOLOGIES CORPORATION, Lincolnshire, IL (US)

(72) Inventors: Yuri Astvatsaturov, Lake Forest, IL (US); Matthew Lawrence Horner, Sound Beach, NY (US); Adithya H. Krishnamurthy, Hicksville, NY (US)

(21) Appl. No.: 18/115,652

(22) Filed: Feb. 28, 2023

(51) Int. Cl. H04N 23/60; G06T 7/00; H04N 5/265; H04N 23/61

(52) U.S. Cl. CPC H04N 23/64; G06T 7/0004; H04N 5/265; H04N 23/61; G06T 2200/24; G06T 2207/20212

(57) ABSTRACT

Automatic grouping in machine vision systems is provided via identifying first and second cameras of a plurality of cameras associated with a machine vision system; displaying, in a graphical user interface, a proposal to operate the first and second cameras as a virtual device in performing a job in the machine vision system using the first and second cameras; and in response to receiving confirmation of the proposal: creating the job in the machine vision system; receiving a first analysis image from the first camera and a second analysis image from the second camera; combining the first analysis image and the second analysis image into a combined image; executing the job on the combined image; and rendering an outcome based on an analysis of the combined image according to the job.

### BACKGROUND

Machine vision systems are often used in product acceptance testing, and provide quality control measures that are based on various captured and analyzed images of the products under test. These machine vision systems may be used in addition to or instead of other testing systems based on weight, electrical properties, or the like, and offer a (potentially) more consistent and accurate screening system than human quality assurance personnel can provide. Various features of the product may be tested for, including the presence and content of identifying markers (e.g., barcodes, labels), product color, surface textures, the presence or absence of various components, orientation, and the like.

Various deployments of machine vision systems may use several cameras to inspect a single product at different stages during manufacture and test or for different locations on the product when the field of view (FOV) of a single camera cannot capture the entire product with sufficient resolution to allow for reliable quality assurance during product acceptance testing. Given the wide array of cues that can be examined visually by a machine vision system, setting up such as system is generally handled by subject matter experts (SMEs) who have detailed understandings of the products being analyzed, the hardware used to collect images of the products, and the software used to perform the analysis from collected images.

### SUMMARY

The present disclosure generally relates to automating the grouping of several cameras in a machine vision system for use as a unified composite camera. The system, which may include artificial intelligence (AI) modules, recognizes cameras that can be grouped together as a unified virtual device so that image results from each camera in the group are used to make a unified quality assessment of a product, rather than a series of individual quality assessments. In some embodiments, the output of the unified camera group can be used to form a composite or mosaic image for analysis, or the images can be kept separate, but the analysis of the virtual device may be tied to one evaluation in a job.

Various examples of the present disclosure may be understood as a method including various operations, a system including a processor and a memory including instructions that when executed by the processor perform various operations, a storage device including instructing that when executed by a processor perform various operations, or a computer program product that performs various operations, the various operations including: identifying a first camera and a second camera of a plurality of cameras associated with a machine vision system, wherein the first camera and the second camera are identified based on a first activation time for the first camera being connected to the machine vision system being within a threshold interval from a second activation time for the second camera being connected to the machine vision system; displaying, in a graphical user interface, a proposal to operate the first camera and the second camera as a virtual device in performing a job in the machine vision system using the first camera and the second camera; and in response to receiving confirmation of the proposal: creating the job in the machine vision system; receiving a first analysis image from the first camera and a second analysis image from the second camera; combining the first analysis image and the second analysis image into a combined image; executing the job on the combined image; and rendering an outcome based on an analysis of the combined image according to the job.

In some embodiments, the first camera and the second camera are identified further based on: identifying an overlap in a first image produced by the first camera with a second image produced by the second camera.

In some embodiments, the first camera and the second camera are identified further based on: activating a light source; and observing a threshold change in contrast or brightness in a first image produced by the first camera and the threshold change in contrast or brightness in a second image produced by the second camera while the light source is activated compared to when the light source is inactive.

In some embodiments, the first camera and the second camera are identified further based on: the first camera being connected to a first port of a computer vision system at a first address within a threshold value of a second address of a second port of the machine vision system that the second camera is connected to.

In some embodiments, the first camera is grouped into a second virtual device with a third camera that is not grouped in the virtual device with the second camera.

In some embodiments, a first output of the first camera and a second output of the second camera are saved to a shared canvas.

In some embodiments, a machine learning model identifies the first camera and the second camera from the plurality of cameras.

In some embodiments, at least one camera of the plurality of cameras is an emulated camera.

Various examples of the present disclosure may be understood as a method including various operations, a system including a processor and a memory including instructions that when executed by the processor perform various operations, a storage device including instructing that when executed by a processor perform various operations, or a computer program product that performs various operations, the various operations including: receiving a plurality of outputs from a corresponding plurality of cameras associated with a machine vision system; analyzing a combined output of the plurality of outputs; identifying a first subset of cameras from the plurality of cameras that provided outputs in the plurality of outputs that include images of a specified portion of an object at or above a specified confidence interval for a machine learning model to determine whether the specified portion satisfies a pass/fail criterion; identifying a second subset of cameras from the first subset of cameras that provide overlapping coverage of the specified portion with one another; identifying a reduced number of cameras from the second subset as a third subset of cameras that provide total coverage of the specified portion; outputting, to a user interface, the third subset of cameras as a virtual device for the machine vision system to use a combined output from; in response to receiving confirmation of the virtual device, generating a job for the virtual device to perform in analyzing an object according to a set of criteria; and recording an analysis result of the virtual device for the job.

In some embodiments, the plurality of cameras includes a plurality of emulated cameras for which a single physical camera provides multiple associated outputs to emulate.

Various examples of the present disclosure may be understood as a method including various operations, a system including a processor and a memory including instructions that when executed by the processor perform various operations, a storage device including instructing that when executed by a processor perform various operations, or a computer program product that performs various operations, the various operations including: identifying a first camera having a first field of view including a first portion of an object under inspection by a machine vision system and a second camera having a second field of view including a second portion of the object under inspection by the machine vision system, wherein the second portion is not included in the first field of view and the first portion is not included in the second field of view; combining a first output of the first camera with a second output of the second camera as a combined output from a virtual device; identifying a quality assurance device for the machine vision system to use in association with a job defined for the virtual device; and activating the quality assurance device according to an analysis of the first portion and the second portion visible in the combined output received from the virtual device according to the job.

In some embodiments, identifying the first camera and the second camera includes: reducing a plurality of cameras associated with the machine vision system to a first subset of nearby cameras; and analyzing images for related FOVs.

In some embodiments, related FOVs see threshold changes in lighting conditions when light source cycled between an active state and an inactive state.

In some embodiments, related FOVs include a shared element of the object in each output.

In some embodiments, the combined output is saved in a shared canvas that the first camera and the second camera both write to.

In some embodiments, the first camera and the second camera capture images of the object at non-overlapping times.

In some embodiments, a machine learning model identifies the first camera and the second camera from a plurality of cameras available to the machine vision system including additional cameras to the first camera and the second camera.

Various examples of the present disclosure may be understood as a method including various operations, a system including a processor and a memory including instructions that when executed by the processor perform various operations, a storage device including instructing that when executed by a processor perform various operations, or a computer program product that performs various operations, the various operations including: identifying a first camera and a second camera of a plurality of cameras associated with a machine vision system, wherein the first camera and the second camera are identified based on at least one of: a first activation time for the first camera being connected to the machine vision system being within a threshold interval from a second activation time for the second camera being connected to the machine vision system; identifying an overlap in a first image produced by the first camera with a second image produced by the second camera; activating a light source, and observing a threshold change in contrast or brightness in a first image produced by the first camera and the threshold change in contrast or brightness in a second image produced by the second camera while the light source is activated compared to when the light source is inactive; or the first camera being connected to a first port of a computer vision system at a first address within a threshold value of a second address of a second port of the machine vision system that the second camera is connected to; displaying, in a graphical user interface, a proposal to operate the first camera and the second camera as a virtual device in performing a job in the machine vision system using the first camera and the second camera; and in response to receiving confirmation of the proposal: creating the job in the machine vision system; receiving a first analysis image from the first camera and a second analysis image from the second camera; combining the first analysis image and the second analysis image into a combined image; executing the job on the combined image; and rendering an outcome based on an analysis of the combined image according to the job.

Various examples of the present disclosure may be understood as a method including various operations, a system including a processor and a memory including instructions that when executed by the processor perform various operations, a storage device including instructing that when executed by a processor perform various operations, or a computer program product that performs various operations, the various operations including: identifying a first camera and a second camera of a plurality of cameras associated with a machine vision system, wherein the first camera and the second camera are identified by a machine learning model as capturing images of one object; displaying, in a graphical user interface, a proposal to operate the first camera and the second camera as a virtual device in performing a job in the machine vision system using the first camera and the second camera to analyze the one object; and in response to receiving rejection of the proposal: creating a first instance of the job for the first camera; creating a second instance of the job for the second camera; capturing a first analysis image with the first camera; capturing a second analysis image with the second camera; executing the first instance of the job on the first analysis image; executing the second instance with the job on the second analysis image; rendering a first outcome based on analysis of the first analysis image according to the job; and rendering a second outcome based on analysis of the second analysis image according to the job.

In some embodiments, the operations further comprise: grouping the first instance and the second instance into a container job; and rendering an overview outcome based on analysis of the first outcome and the second outcome according to the container job.

In some embodiments, the first instance of the job is executed by the first camera; the second instance of the job is executed by the second camera; and the container job is executed by one of the first camera or the second camera.

In some embodiments, wherein the machine learning model identifies which one of the first camera and the second camera to execute the container job based on a time of capture for the first analysis image and the second analysis image.

In some embodiments, the first instance of the job is executed by the first camera; the second instance of the job is executed by the second camera; and the container job is executed by a controller for the machine vision system.

In some embodiments, the rejection of the proposal includes an indication of at least one of: that the machine learning model misidentified multiple objects as one object; that an analysis output for the first camera is used as an input for a job for the second camera; or that a time difference in capturing images via the first camera exceeds a timing threshold for capturing images via the second camera.

Various examples of the present disclosure may be understood as a method including various operations, a system including a processor and a memory including instructions that when executed by the processor perform various operations, a storage device including instructing that when executed by a processor perform various operations, or a computer program product that performs various operations, the various operations including: identifying a first camera and a second camera of a plurality of cameras associated with a machine vision system, wherein the first camera and the second camera are identified by a machine learning model as capturing images of one object; displaying, in a graphical user interface, a proposal to operate the first camera and the second camera as a virtual device in performing a job in the machine vision system using the first camera and the second camera to analyze the one object; and in response to receiving a command to create a container job based on the proposal: creating a first instance of the job for the first camera; creating a second instance of the job for the second camera; capturing a first analysis image with the first camera; capturing a second analysis image with the second camera; executing the first instance of the job on the first analysis image; executing the second instance with the job on the second analysis image; rendering a first outcome based on analysis of the first analysis image according to the job; rendering a second outcome based on analysis of the second analysis image according to the job; and rendering an overview outcome based on the analysis of the first analysis image and the analysis of the second analysis image according to the container job.

In some embodiments, the command to create the container job includes an indication of at least one of: that the machine learning model misidentified multiple objects as one object; that an analysis output for the first camera is used as an input for a job for the second camera; or that a time difference in capturing images via the first camera exceeds a timing threshold for capturing images via the second camera.

In some embodiments, the operations further comprise: activating a quality assurance device associated with the container job according to the overview outcome, wherein the quality assurance device includes at least one of: a light pole; a sound producing device; or a pass/fail sorting mechanism.

Various examples of the present disclosure may be understood as a method including various operations, a system including a processor and a memory including instructions that when executed by the processor perform various operations, a storage device including instructing that when executed by a processor perform various operations, or a computer program product that performs various operations, the various operations including: receiving a plurality of datasets, each of the plurality of datasets being associated with one of a corresponding plurality of imaging devices of the machine-vision system; identifying a first imaging device and a second imaging device from the plurality of imaging devices as candidate devices for grouping based on (i) the plurality of datasets being evaluated by an auto-grouping model and (ii) the auto-grouping model determining that a first dataset associated with the first imaging device and a second dataset associated with the second imaging device fall within grouping criteria of the auto-grouping model; in response to identifying the candidate devices, outputting a proposal to group the candidate devices; in response to receiving a confirmation of the proposal: conducting at least a portion of a machine-vision job in association with the candidate devices; analyzing image data obtained by the candidate devices; and rendering an outcome based on the analyzing of the image data according to criteria defined by the machine-vision job.

In some embodiments, the proposal is output via a graphical user interface.

In some embodiments, the candidate devices include at least a third imaging device in addition to the first imaging device and the second imaging device.

In some embodiments, the each dataset of the plurality of datasets includes image data associated with one imaging device of the plurality of imaging devices of the machine-vision system.

In some embodiments, at least one of the imaging devices of the plurality of imaging devices is an emulated imaging device.

In some embodiments, the grouping criteria of the auto-grouping model includes a visual overlap in respective image data associated each of the first imaging device and the second imaging device that satisfies an overlap threshold value.

In some embodiments, the grouping criteria of the auto-grouping model includes a visual similarity in the respective image data associated the first imaging device and the second imaging device.

In some embodiments, the operations further include: activating a light source; capturing the image data associated with each imaging device of the plurality of imaging devices of the machine-vision system; and identifying the first imaging device and the second imaging device from the plurality of imaging devices as the candidate devices based on the image data associated with the first imaging device and the second imaging device having a threshold change in at least one of a contrast or a brightness.

In some embodiments, the each of the plurality of datasets includes device-activation time data associated with a corresponding imaging device of the plurality of imaging devices of the machine-vision system.

In some embodiments, each dataset of the plurality of datasets includes network address data associated with a corresponding imaging device of the plurality of imaging devices of the machine-vision system.

In some embodiments, the auto-grouping model is a machine learning model.

In some embodiments, the auto-grouping model is not a machine learning model.

In some embodiments, the analyzing image data obtained by the candidate devices includes executing at least one tool of the machine-vision job on at least one of (i) each respective dataset associated with the auto-grouping candidate devices, or (ii) a combined dataset of the auto-grouping candidate devices.

In some embodiments, in response to receiving a modification to the proposal, the operations further include, before conducting at least the portion of the machine-vision job in association with the candidate devices: (i) adjusting which ones of the plurality of imaging devices belong to the candidate devices or (ii) adjusting settings for the candidate devices that belong to the candidate devices.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example machine vision system and a product under test, according to embodiments of the present disclosure.

FIG. 2 illustrates an example GUI with a proposal to combine several cameras providing associated images into a single virtual device for evaluating a product under test, according to embodiments of the present disclosure.

FIG. 3 illustrates an example GUI with a shared canvas showing the combined images from the proposed cameras to use in a virtual device, according to embodiments of the present disclosure.

FIG. 4 illustrates an example GUI with a proposal to combine several cameras providing purportedly associated images into a single virtual device for evaluating a product under test, according to embodiments of the present disclosure.

FIG. 5 illustrates an example proposal and rejection of a shared canvas in favor of individualized canvases on which multiple instances of the same job are run, according to embodiments of the present disclosure.

FIG. 6 is a flowchart of an example method for providing automatic grouping in machine vision systems, according to embodiments of the present disclosure.

FIG. 7 is a flowchart of an example method for executing a job on an image in machine vision systems, according to embodiments of the present disclosure.

FIG. 8 illustrates an example computing device, according to embodiments of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure generally relates to automating the grouping of several cameras in a machine vision system for use as a unified composite camera. The system, which may include artificial intelligence (AI) modules, recognizes cameras that can be grouped together as a unified virtual device so that image results from each camera in the group are used to make a unified quality assessment of a product, rather than a series of individual quality assessments. In some embodiments, the output of the unified camera group can be used to form a composite or mosaic image for analysis, or the images can be kept separate, but the analysis of the virtual device may be tied to one evaluation in a job.

As used herein, the term “job” refers to a set or series of criteria to evaluate a product against to pass or fail inspection. As used herein, the term “tool” refers to a specific analysis to perform according to the criteria of a job. For example, when performing a job to ensure a parcel is properly routed in a postal system, a first criterion may be to determine if a legible delivery address has been provided, and a second criterion may be to determine if sufficient postage is affixed. A first tool to analyze the criterion of legible delivery address may be an optical character recognition (OCR) tool to read a section of the parcel identified as containing an address, and a second tool for presence recognition to determine whether a sufficient number of postage stamps have been applied to the parcel may be operable to evaluate whether to pass the parcel or fail the parcel for forwarding to the addressee. However, additional or alternative tools may be operable to evaluate the parcel according to the same job. Additionally, several instances of the same tool may be applied with various settings so that the same tool may be used multiple times during a job. Returning to the example of the parcel, the first tool may be used to read a different section of the parcel to identify if a return address is present and legible to route the parcel back to the sender if delivery is unsuccessful.

Rather than relying on a human operator to manually identify cameras to group together into a virtual device, the automated system uses various features of the cameras to identify potential groups for approval by the human operator. For example, when identifying cameras for inclusion in a potential group, an AI-based module can recognize several cameras that are configured to evaluate the same part of a product. For instance, a system can be configured to recognize that a series of cameras are pointed at different parts of a car door. This determination can lead to an automatic grouping of those cameras into a virtual device. Other non-AI-based means can also be implemented. This can include evaluation of overlapping regions over various Fields of View (FOVs) and generating groups based on the existence of such overlaps.

In some embodiments, the virtual device can be configured so that the component cameras grouped together (optionally) behave as a single camera; with the ability to act upon and generate outputs, share a common image canvas, and use the UI to create tasks that may span multiple cameras within the group.

In some embodiments, auto-grouping can is performed with emulated cameras. For example, when the job creation application used for automated grouping supports device emulation, a user can create a job without having real devices connected to the application for every camera indicated in the UI. Instead, the operator can add multiple inputs from one camera (e.g., taken at different times and settings) or other simulated cameras that the system treats as inputs from a corresponding number of deployed “real” cameras. From these inputs, the system emulates a separate camera providing each input when auto-grouping the cameras, thereby allowing the operator to “plan out” a multi-camera deployment before installing real analogues to the emulated devices. For example, an operator can thereby use a single camera, take pictures at various locations of the product, and upload those pictures to the emulators to decide which camera positions give the best grouping in terms of covering fields of view.

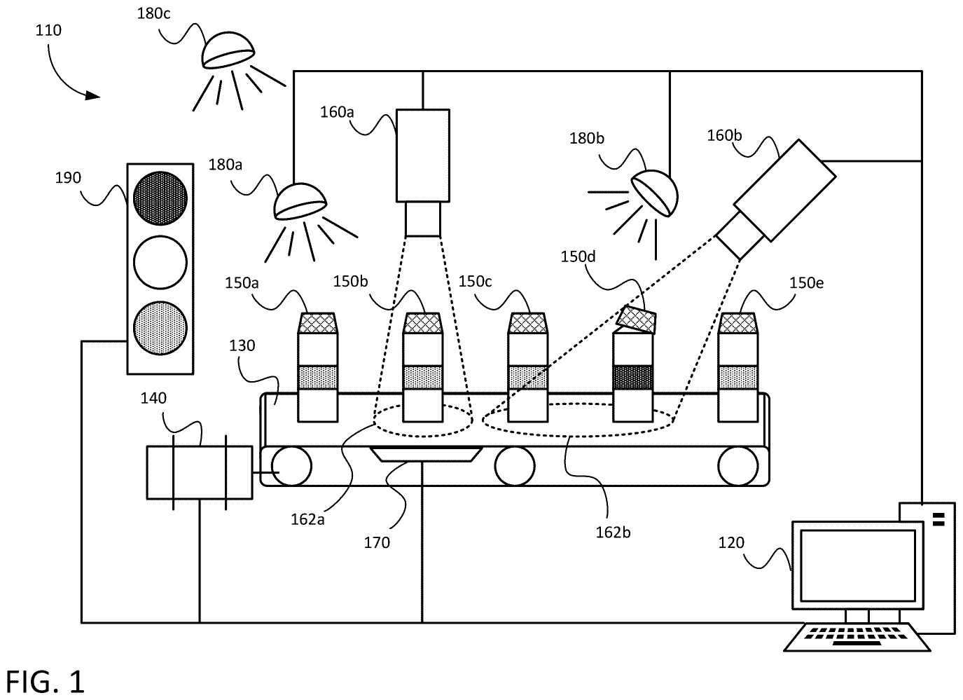

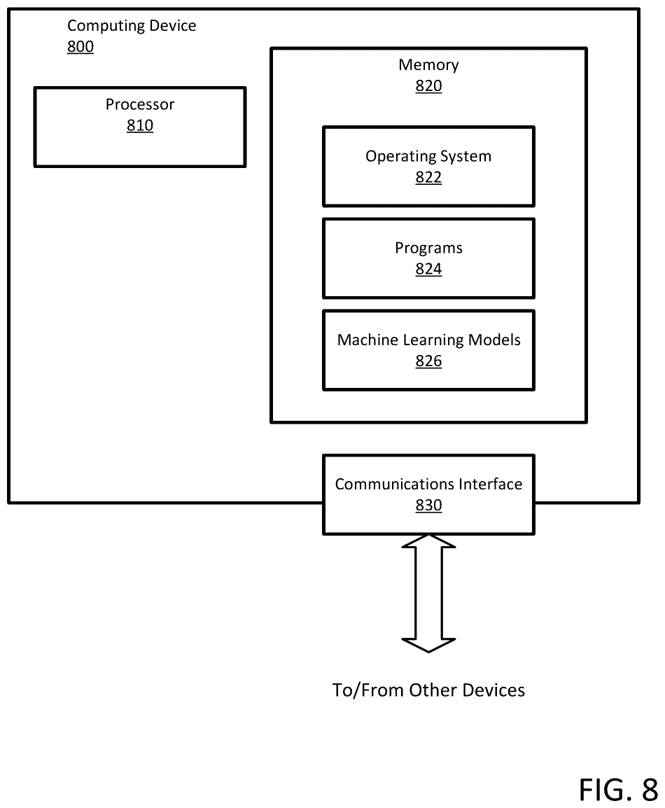

FIG. 1 illustrates an example machine vision system 110 and product 150a-e (generally or collectively, product 150) under test, according to embodiments of the present disclosure. A controller 120, which may be computing device 800 as is described in greater detail in relation to FIG. 8, is in communication with various components of the machine vision system 110 to evaluate the products 150 that are under test, and indicate to operators the results of the analysis. In various embodiments, the controller 120 performs various jobs, which may be set up on the controller 120 or imported from another computing device one which the job was initially created. Similarly, in some embodiments, the controller 120 can store the inputs and results of the analyses locally (e.g., on a hard drive or other memory of the controller 120) or remotely (e.g., on another computing device or memory controller by another computing device).

As illustrated in FIG. 1, the machine vision system 110 includes a pathway 130 on which the product 150 travels to be evaluated. In various embodiments, an operator can manually place the product 150 on the pathway 130, or the pathway 130 may be mechanized to move product 150 through the evaluation. When mechanized, one or more motors 140 under the control of the controller 120 can selectively advance, return, rotate, shift (e.g., between separate sub-units of the pathway 130) are selectively activatable to control how and when the product 150 move during test. When not mechanized, the pathway 130 may be traversed by a product 150 that is self-mobile (e.g., a car under inspection), loaded by a human operator, or fed via gravity. In some embodiments, the pathway 130 includes a conveyer belt, rollers, doors, chutes, slides, robotic armatures, and other means by which the product 150 is moved to one or more designated areas for analysis by various instruments included in the machine vision system 110.

Various visual instruments in the machine vision system 110 can capture images of the products 150 undergoing analysis, which are transferred to the controller 120 to evaluate against a job for the given product 150. For example, one or more cameras 160a-b (generally or collectively, camera 160) can collect still images at specified times, or continuously capture images (e.g., as video) over a time duration. Each camera 160a-b has an associated field of view (FOV) 162a-b (generally or collectively, FOV 162) in which objects are visible to the respective camera 162a-b. Additionally, in some embodiments, the cameras 160 may include or be associated with various positional motors, zoom controls, aperture controls, supplemental light sources (e.g., flashes, lasers), and the like that allow for the camera 160 to change the size, shape, lighting, and location of the associated FOV 162. In various embodiments, the cameras 160 include a computing device (such as described in greater detail in regard to FIG. 8), which may be used to pre-process (e.g., crop, color/contrast adjust, add metadata) or cache collected images before transmission to the controller 120.

In various embodiments, non-visual instruments 170 can be incorporated in the machine vision system 110, which may include scales, voltmeters, ohmmeters, ammeters, chemical “sniffers”, light curtains, positional sensors, thermometers, or the like. These non-visual instruments 170 provide additional data to the controller 120 to evaluate the products 150 in addition to the visual features captured in images by the cameras 160.

Various light fixtures 180a-c (generally or collectively, light fixtures 180) may be under the control of the controller 120 (e.g., first and second light fixtures 180a-b) to selectively illuminate some or all of the machine vision system 110 when analyzing products 150, while other light fixtures 180 (e.g., third light fixture 180c) may be outside of the control of the controller 120 (e.g., light fixtures for other machine vision systems, environmental lighting, etc.). In various embodiments, the light fixtures 180 illuminate different portions of the machine vision system 110 or products 150 thereon at varying intensities, times, and using various wavelengths of light (e.g., infrared, visual spectrum, ultraviolet) to improve the visibility of various features of the products 150, while reducing visual interference between the products 150 (e.g., reflections, glare, shadows). The controller 120 therefore is able to adjust the timing, magnitude of illumination, and composition of the light provided by (at least some of) the light fixtures 180 used to illuminate the products 150 and the machine vision system 110 during visual inspection. In various embodiments, the aperture of the light fixture 180 may also be controlled to affect a beam size of the light directed onto the machine vision system 110 or products thereon. The light fixtures 180 may include incandescent, fluorescent, or Light Emitting Diode (LED) luminaires, or may include lasers in various embodiments.

Visual inspection of the products 150 allows the controller 120 to identify which products 150 to not meet various test criteria that may not be detectable via the non-visual instruments, or may be ascribed to multiple causes. For example, the fourth product 150d is illustrated with a different appearance than the other products 150 in FIG. 1; having a misaligned cap and a different color label than the other products 150. These defects in construction or appearance may not be detectable via non-visual instruments 170, as the fourth product 150d may have substantially the same weight, temperature, chemical composition, electrical characteristics, etc., as the other products 150, but is not in an acceptable state. In various embodiments, the controller 120 is in communication with an indicator 190, such as a light pole, speaker or other sound producing device, or a pass/fail sorting mechanism to identify to operators when a product 150 passes or fails inspection, or to separate passing products 150 from failing products 150.

Initial setup of the cameras 160 and light fixtures 180 (including the number, placement, and controlled settings thereof) can affect what jobs are available for creation, and how the products 150 are evaluated. This setup process, can be challenging and time consuming given the complexity of the product 150 to be evaluated and the number of components of the machine vision system 110 that can be controlled by the controller 120 to affect the images of the products 150 under test. Accordingly, the present disclosure provides for the use of machine learning models and graphical user interfaces (GUIs) that provide a streamlined evaluation and camera grouping interface for use with the machine vision system for use in initial setup and later refinement of a machine vision system.

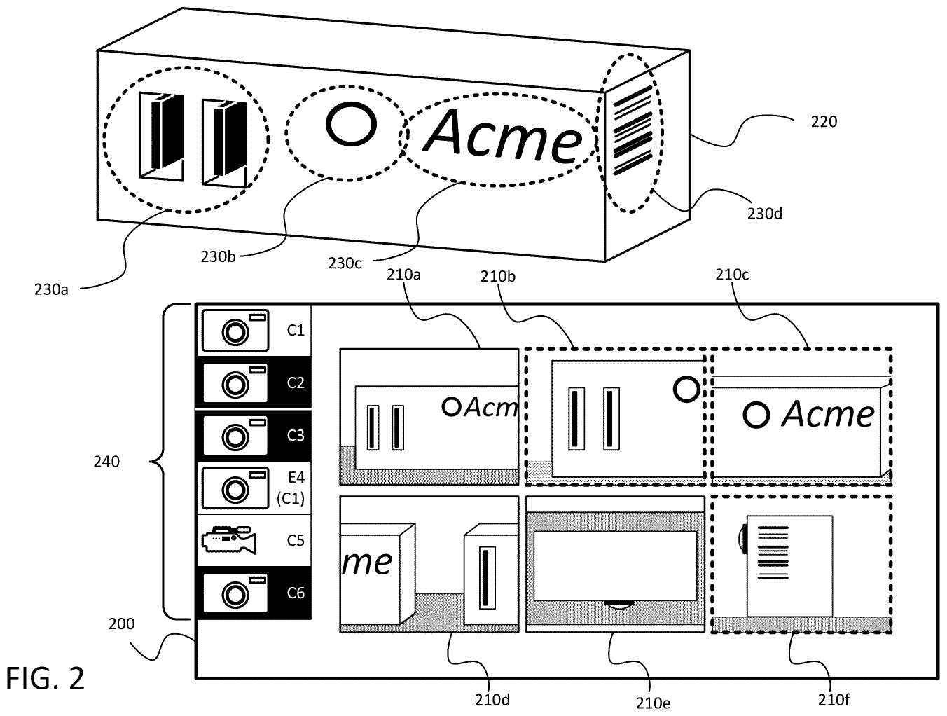

FIG. 2 illustrates an example GUI 200 with a proposal to combine several cameras providing associated images into a single virtual device for evaluating a product under test, according to embodiments of the present disclosure. For reference, an object 220 representing the product under test is shown with several features representing criteria 230a-d (generally or collectively, criterion 230 or criteria 230) to evaluate as part of a job, and with windows 210a-e (generally or collectively, window 210) in the GUI 200 showing these images with those from the proposed cameras to combine highlighted (e.g., via dashed outline).

Additionally or alternatively to allowing section via the windows, various camera indicators 240 may be included in the GUI 200 to allow the operator to see which cameras are selected, and make changes in the selection thereby. As illustrated, the camera indicators 240 include graphics to identify the types of camera used by the machine vision system and text to identify the individual cameras, including which physical camera was used when the indicated camera is an emulated camera. For example, camera four may be indicated as an emulated camera as “E4” that uses the hardware of camera one “C1”. As will be appreciated, more or fewer camera indicators 240 may be included in other embodiments based on the number of cameras (physical or emulated) available to the machine vision system.

In various embodiments, these criteria 230 may include presence/absence determinations and counting for various features, barcode reading, optical character recognition and matching, surface feature identification, defect analysis, image filters, color matching, counting, geometry comparison, and other 2D or 2D machine visions tools. In an automotive industry example, the tools can include pattern matching, measurement (e.g., circle tools), line, contrast/pixel, Barcode reading, and Optical Character Recognition (OCR). In a fastener manufacturing or solar industry example, the tools can include pattern recognition, Measurement, Line, Contrast/Pixel, and counting tools. In a durable consumer goods example (e.g., washing machines), the tools can include locate, pattern matching, Measurement, Line, Contrast/Pixel, and counting tool. In a food and beverages industry example, the tools can include missing cap, quality of cap, surplus material, spill near cap-Locate, Blob tools, Cap Ring inspection-spill-Locate tool, Deformation of bottle-Pattern tool, Quality of container-color, filter, Pattern tools, Inspection of bottom-colored spots-Pattern, Blob tools, Inspection of particles-floating, particles in liquid, Filling Level-Edge detection, Contrast, Reading-OCR, Optical Character Verification (OCV), 1D-2D barcodes, and the like.

In various embodiments, a machine learning model determines which of the images from a plurality of cameras provide a first subset that include images of a specified portion of an object 220 at or above a specified confidence interval for a machine learning model to determine whether the specified portion satisfies a pass/fail criterion (e.g., a threshold brightness, contrast, resolution). From this first subset, the machine learning model may identify a second subset of cameras that provide overlapping coverage of the specified portion with one another such that the outputs of the various cameras can be combined with one another with at least a threshold level of confidence. Images from the second subset are displayed in the windows 210, with a third subset (identified as a reduced number of cameras from the second subset) shown with highlighting to provide a proposal to the operator to select as a combined virtual device. In various embodiments, the proposal may be output via a Graphical User Interface, via audio cues, or signals transmitted to other devices to provide to an operator.

Generally, the machine learning model attempts to identify a reduced subset of the available cameras that still provide total coverage of the areas of interest to evaluate the features identified according to the pass/fail criteria. The associated outputs from these cameras are combined and saved to a shared canvas for shared evaluation against the specified criteria, where the multiple images with related FOVs are joined into a single image for evaluation. Each camera, as part of the virtual device, writes its associated output to the shared canvas (either contemporaneously or at different times) to develop an expanded or more detailed vision of the object under test. In the shared canvas, multiple images from the selected cameras may be joined together (e.g., to expand a FOV) or layered over one another (e.g., to provide greater detail in certain areas, or provide alternative details taken under different construction or lighting conditions). For example, a first image of a barcode taken using natural lighting may be layered with a second image of that same barcode taken using ultraviolet lighting to provide additional detail on the data contents of that barcode.

Although machine learning models are generally discussed as determining which cameras to group together in a proposed grouping, in various embodiments, other auto-grouping models may be used that are programmatically configured to identify groups of cameras based on various thresholds or other sufficiently similar features in data sets related to the various cameras.

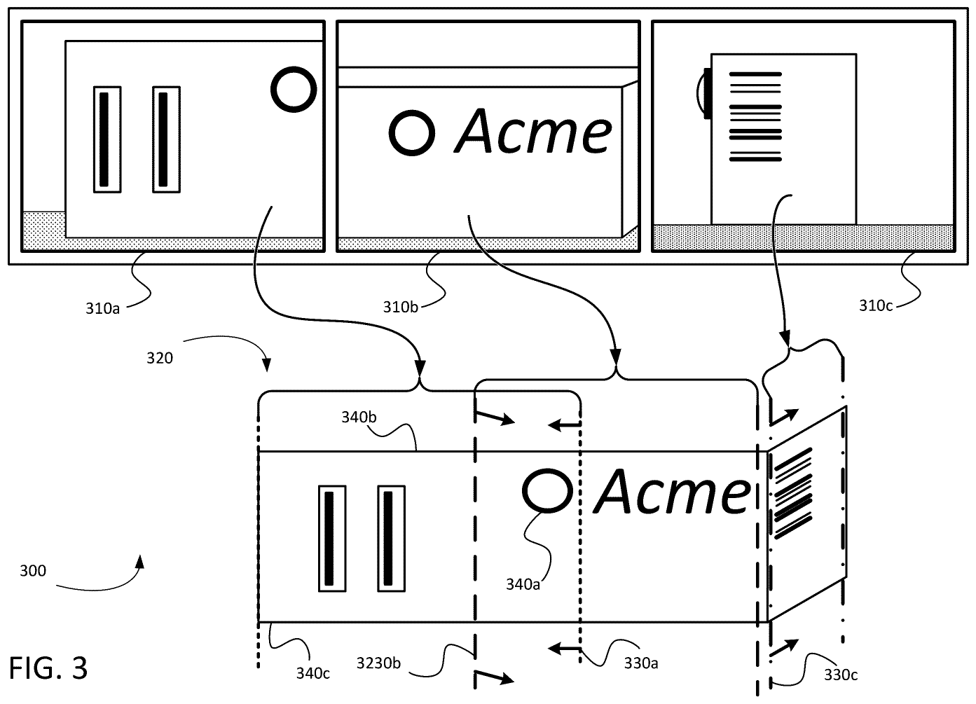

FIG. 3 illustrates an example GUI 300 with a shared canvas 320 showing the combined images from the proposed cameras to use in a virtual device, according to embodiments of the present disclosure. Each of the collected images, shown in the window 310a-c (generally or collectively, window 210) that are proposed to the operator to select between are spliced together in the shared canvas 320 to create a composite image for analysis according to various test criteria for a job.

In various embodiments, the proposal shown in the windows 310 are given as selectable options to the operator to choose from to automatically stitch together. Accordingly, an operator may select an image in a new window 310 for inclusion in the shared canvas 320, or may de-select an image from an already-selected window 310 to remove that image from the shared canvas. On confirmation of the images to include in the shared canvas, the machine vision system groups together the associated cameras as a virtual device. As illustrated, an operator has selected the images in the first through third windows 310a-c (e.g., out of the options provided in the windows 210 shown in FIG. 2), which the machine vision system has spliced together into a single image in the shared canvas 320. To indicate the overlap between the individual images, the GUI 300 may include overlap lines 330a-c (generally or collectively, overlap lines 330) that indicate where the elements from one image ends within the scope of another image.

Because the images collected from the individual cameras are taken at potentially different angles relative to the object, different lighting conditions, different relative distances to the object, and with different hardware (e.g., with different resolutions, color sensitivities, f-stop settings, or the like), and may be taken of different surfaces of the object, the machine vision system may use a machine learning model to identify shared features 340a-c (generally or collectively, shared features 340) across the images. These anchoring points can be used as anchoring points to resize, reorient, re-color, crop, and overlay the individual images to match one another across two or more images. As illustrated, a light element is identified as a first shared feature 340a, an upper edge of a front face of the object is identified as a second shared feature 340b, and a lower edge of the front face of the object is identified a third shared feature 340c. Accordingly, the machine learning model is able to identify commonalities between different images to thereby join the images in the shared canvas 320.

For example, the image shown in the first window 310a is sized and positioned relative to the image shown in the second window 310b to orient the respective top edges and the bottom edges of the object with one another and the respective lighting elements with one another. The image shown in the third window 310c is sized and positioned in a different plane than the images shown in the first and second windows 310a-b, but is oriented based on the top and bottom edges meeting those in the other images, and the position/size of the lighting element (shown in profile versus face-on).

In various embodiments, the overlap lines 330 indicate a planar alignment of the images used in the shared canvas 320. Because some of the images may be captured at different angles relative to the object when extracting features from a shared face, or be taken of different faces of the object, when the individual images are processed for inclusion in the shared canvas 320, those images may be reoriented to fit a 2D shared canvas 320, or combined in a 3D model within the shared canvas 320. Accordingly, the overlap lines 330 provide operators with visual indicators for how the individual images are joined together, and may serve as a control point in the GUI 300 for the operator to adjust how the images are joined together.

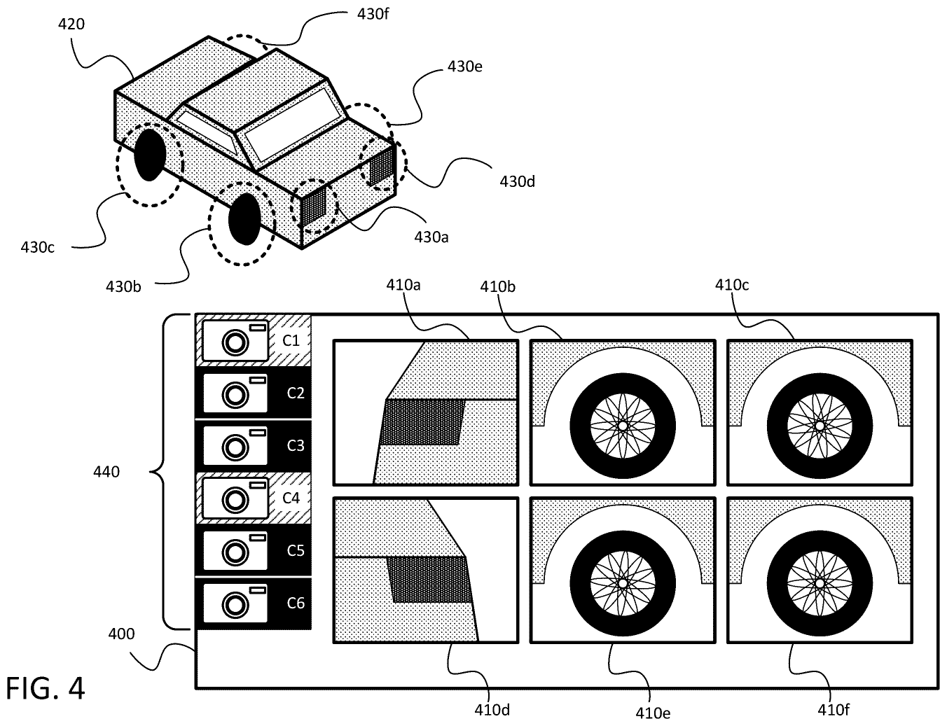

FIG. 4 illustrates an example GUI 400 with a proposal to combine several cameras providing purportedly associated images into a single virtual device for evaluating a product under test, according to embodiments of the present disclosure. For reference, an object 420 representing the product under test is shown with several features representing criteria 430a-f (generally or collectively, criterion 430 or criteria 430) to evaluate as part of a job, and with windows 410a-e (generally or collectively, window 410) in the GUI 400 showing these images. Corresponding camera indicators 440a-f are shown in the GUI 400 that correspond to the cameras that produced the images shown in each of the window 410 (e.g., first camera indicator 440a corresponds to the camera that produced the image in the first window 410a, second camera indicator 440b corresponds to the camera that produced the image in the second window 410b, etc.).

As shown in FIG. 4, a machine learning model has identified two groups of cameras for use as virtual devices, and has shown this proposal in the GUI 400 by applying two sets of highlights to the associated camera indicators 440. In various embodiments, in addition or alternatively to highlighting the camera indicators 440, the GUI 400 may highlight the associated windows 410. In the present example, the second camera, third camera, fifth camera, and sixth camera are selected as one group that is believed by the machine learning model to represent alternative views of a first object under inspection (a wheel). Similarly, the first and fourth cameras are selected as one group that is believed by the machine learning model to represent alternative views of a second object under inspection (a tail light).

As indicated on the object 420, however, the operator is interested in inspecting for six criteria 430a-f; two tail lights (e.g., criteria 430a, 430d) and four wheels (e.g., criteria 430b-c, 430e-f). Accordingly, in the present example, the machine learning model has misidentified the four individual images of different wheels as being alternative images of the same wheel, and the two individual images of different tail lights as being alternative images of the same tail light. Following this example, although the machine learning model may propose a shared canvas for virtual device to an operator that combines several the outputs of several cameras together, the operator is expected to reject these proposals.

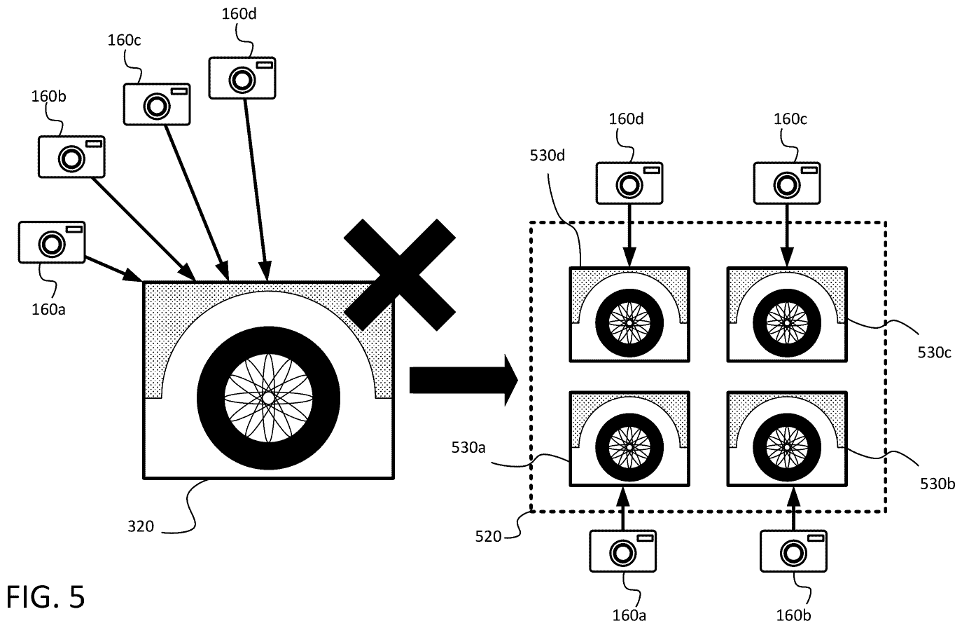

FIG. 5 illustrates an example proposal and rejection of a shared canvas 320 in favor of individualized canvases 530a-d (generally or collectively, individualized canvas 530) on which multiple instances of the same job are run, according to embodiments of the present disclosure.

Similarly to the example given in relation to FIG. 4 in relation to wheels, FIG. 5 shows an initial proposal to group together the outputs of several cameras 160a-d into a single image on a shared canvas 320. In various embodiments, a machine learning model makes the proposal based on identify a plurality of cameras to group together based on at least one of: a activation times for the camera being connected to the machine vision system being within a threshold interval of one another; identifying overlaps in images produced by the cameras; activating a light source, and observing a threshold change in contrast or brightness in images produced by the cameras compared to when the light source is inactive; or the cameras being connected to port of a computer vision system at addresses within a threshold value each other.

When the operator rejects the proposal, the GUI may provide, as a fallback position, the option for the individual images to remain as separate images in individualized canvases 530 and for the operator to propagate the job initially proposed for use on the shared canvas 320 as separate instances on the individualized canvases 530. Accordingly, the machine learning model improves the efficiency of deploying similar jobs for analyzing objects that were similar enough to be confused as being alternative images of the same object.

In another example, the operator may reject the proposal to combine the images for analysis on a shared canvas 320 when the timing of when the images are captured is not conducive for shared analysis. For example, when the first camera 160a captures a first image at the beginning of a manufacturing or quality assurance process to make a first determination to take one of several potential actions, and the second camera 160b captures a second image at a second time and the end of the manufacturing or quality assurance process, waiting for the second image (as a component in the shared canvas 320) may not be possible or conducive to making the determination at the first time for which potential action to take. However, the first image and the second image may be useful as part of a container job, which the operator can select to provide in a container canvas 520 that that combines the individual analyses to make a container outcome determination. Accordingly, the GUI and machine learning model may offer the operator the option to reject the proposal to use the combined images for analysis in a shared canvas 320, but to combine the individual outcome determinations of the separate images to generate an overview outcome determination that can take the individual analyses into account.

For example, when the operator is analyzing the wheels on a vehicle, the operator may reject a proposal to combine cameras used to capture the images of the individual wheels as a virtual device, and instead propagate four instances of the same job (including the same analysis tools) to analyze each wheel separately (e.g., to individually determine if the correct wheel is placed on the vehicle, that the wheel is undamaged, that the wheel is properly aligned and connected to the vehicle, etc.). The operator can then set up a container job to determine whether all four wheels pass respective individual analyses (e.g., the car has all four of the correct wheels attached).

In a further example, the machine vision system is used to analyze a sequential process via a first analysis of a first image to determine whether to perform an optional cleaning process, and a second analysis of a second image to determine if the object (whether subjected to the cleaning process or not) is clean enough to pass inspection. In this example, the operator may reject a proposal to combine the first camera and second camera (used to capture the first and second images of the object) as a virtual device, and instead propagate two instances of a job to inspect for cleanliness of the object, which are used to determine whether to activate respective quality assurance devices to optionally send the object for supplemental cleaning based on analysis of the first image and make a pass/fail determination based on analysis of the second image. In various embodiments, after propagating the instances of a core job for analysis of the individual images, an operator may make adjustments, additions, or subtractions to the tools and settings thereof included in each of the individual jobs.

In a further example, the machine vision system is used to analyze a sequential process via a first analysis of a first image to determine whether to perform a first supplemental inspection or a second supplemental inspection, and a second analysis of a second image that performs one of the first supplemental inspection or the second supplemental inspection based on the analysis of the first image. In this example, the operator may reject a proposal to combine the first camera and second camera (used to capture the first and second images of the object) as a virtual device, and instead propagate two instances of a job to inspect the object, and set up a container job that uses the analysis outcome from the first instance of the job to affect how the second instance of the job is performed. For example, the first analysis output may be used to set values for settings in the second instance of the job to change what colors, positions, objects, text, barcodes, etc. are considered passing or failing according to the job.

In various embodiments, some or all of the various jobs may be executed on the cameras that capture the images, and the analysis outcomes are passed to a controller for the machine vision system (or other centralized computing device) to record or activate associated quality assurance devices (e.g., light poles, sirens, actuators, motors, etc.), or may sent directly (e.g., bypassing a centralized computing device) to activate associated quality assurance devices. In some embodiments, the some or all of the various jobs may be executed on the controller for the machine vision system (or other centralized computing device) that receives the images captured by the various cameras to centrally determine the analysis outcomes of the various jobs based on the contents of the images and record or activate associated quality assurance devices (e.g., light poles, sirens, actuators, motors, etc.).

In embodiments in which a container job is defined, or in which a shared job using a shared canvas 320 is approved, and in which job processing occurs on one or more of the cameras, the machine learning model determines which of a centralize computing device or one of the cameras is to perform the final analysis. For example, when the cameras include computing devices that are capable of executing the jobs, the machine learning model may using the timing at which the various images are captured and designate the camera that captures the last image (e.g., at the latest time) to perform the container job or the shared job. Accordingly, the designated camera may receive the images from the other images to populate the shared canvas 320 on which to execute the shared job, or may receive the individual outcomes determined by the other cameras for the respective instances of the job and thereby perform the analysis of the container job in additional to the localized instance of the job on the image captured by the designated camera.

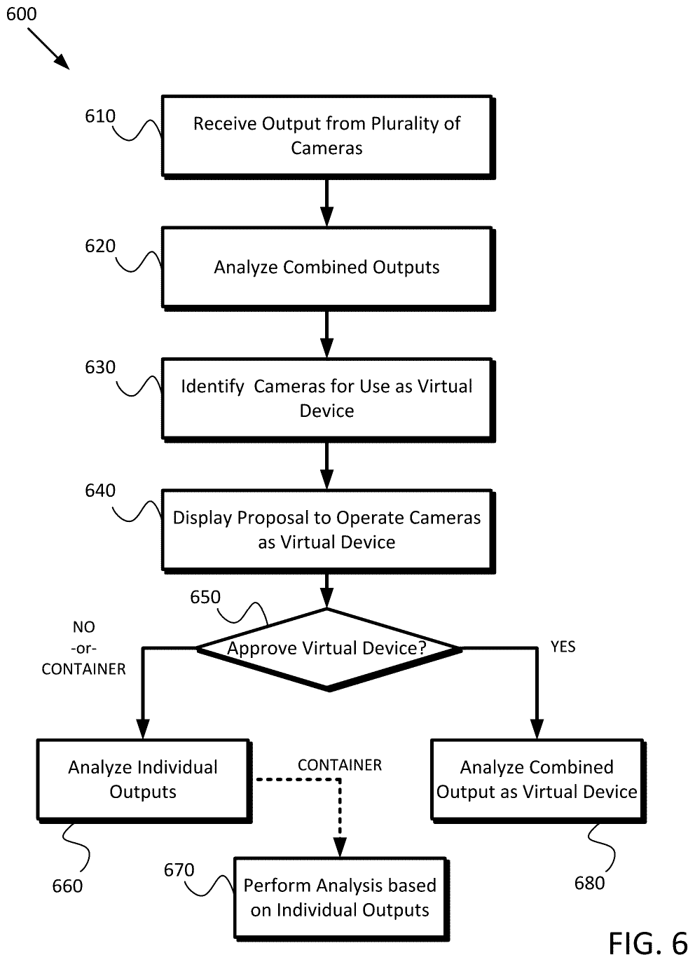

FIG. 6 is a flowchart of an example method 600 for providing automatic grouping in machine vision systems, according to embodiments of the present disclosure. Method 600 begins at block 610, where the controller for a machine vision system receives outputs from a plurality of cameras from a plurality of different FOVs and/or imaging settings. In various embodiments, the outputs may include outputs from real cameras currently deployed in the machine vision system as well as outputs from virtual cameras (e.g., real cameras with different locations or settings than those currently used in the machine vision system). For example, an operator may wish to test several potential configurations for a set of cameras, and may use one camera multiple times (e.g., at different locations and settings) to provide up to N different outputs to compare as being from “virtual” or emulated cameras. The various outputs may be received contemporaneously (e.g., at overlapping times), or at different non-overlapping times, and may include various combinations of video or still images for comparison among the outputs.

At block 620, the controller analyzes the combined set of outputs from the plurality of cameras (received per block 610). In various embodiments, the controller uses a machine learning model to identify commonalities between the various cameras based on the outputs received from the images. The commonalities can include one or more of: the activation times for the individual cameras being connected to the machine vision system (e.g., within a threshold interval from one another); overlap in images produced by the cameras; threshold changes in contrast or brightness in a two or more images produced by corresponding cameras while a light source is activated compared to when the same light source is inactive; port identities/addresses for the computer vision system to which the cameras are connected to; physical proximity of the camera; the presence of a shared element of an object in the outputs (e.g., a threshold number of pixels captured by a first camera in a first image of an matching a second image of the object captured by the second camera); and the like.

At block 630, the controller identifies cameras from the plurality of cameras for (potential) use as a virtual device. In various embodiments, a machine learning model identifies a subset of the available cameras to use the combined outputs of as a single virtual device. For example, a first camera and a second camera may be selected as a subset from the set of available cameras for use as a virtual device. Although the examples given herein primarily associate two cameras together as a virtual device (e.g., a first camera and a second camera), the present disclosure contemplates that any number of cameras can be associated together as a virtual device. For example, a first camera may be grouped by itself as two emulated cameras that provide outputs captured at different times (e.g., under different lighting conditions) as one virtual device, or two or more cameras may be grouped into a virtual device that combined images captured by the respective cameras at the same or different times relative to one another.

In various embodiments, one camera (and the output thereof) may be used, or be proposed for use, in one or more virtual devices. For example, a first camera can be used contemporaneously in a first virtual device (e.g., with a second camera, and not with a third camera) and in a second virtual device (e.g., with a third camera, and not with the second camera).

At block 640, the controller outputs a proposal of the identified cameras (identified per block 630) to operate as a virtual device. In various embodiments, the controller outputs the proposal in a GUI with the individual images of the object shown in sub-windows, and a shared canvas that includes the combined images. In various embodiments, the controller can display various selectable elements of alternative cameras to those initially proposed for use as the virtual device for an operator to select between. For example, a machine learning model may select a first camera and a second camera from a plurality of cameras for use as a first virtual device, and present the corresponding first output and second output along with a shared canvas that combines the first and second outputs. Continuing the example, the machine learning model may also present in the GUI a third output from a third camera, which on selection by an operator, is combined in the shared canvas with the first and second outputs. Similarly, an operator may de-select a proposed or currently selected output to remove the effect thereof from the shared canvas.

At block 650, the controller receives feedback from the operation for whether the proposed virtual device is approved for use in a shared job combining the outputs of several cameras in a shared canvas for analysis via the shared job, or that the proposal has been rejected. In various embodiments, a rejection can include instructions from the operator to analyze the images separately to generate individual outputs or to analyze the images separately and use the individual outputs as part of a container job. When the operator approves the proposal, method 600 proceeds to block 670. Otherwise, when the operator rejects the proposal or selects to set up a container job using the proposed cameras, method 600 proceeds to block 660.

In various embodiments, when the operator rejects the proposal, the proposal may include an indication from the operator for why the proposal was rejection, which may be used in retraining the machine learning model to make better proposals in the future. For example, the indication may indicate at least one of: that the machine learning model misidentified multiple objects as one object; an analysis output for the first camera is used as an input for a job for the second camera; that a time difference in capturing images via the first camera exceeds a timing threshold for capturing images via the second camera, etc.

At block 660, each of the images captured by the several cameras are analyzed individually according to the jobs set for those images. For example, N cameras capture N images, each of which is analyzed by the various tools and setting therefore for the job specified for the respective image. In various embodiments, as a time and computing resource saving measure, when the operator chooses to perform individual analyses on the multiple images from the cameras initially selected for inclusion in a virtual device are initially provisioned with an instance of a core job (e.g., the same job with the same tools and settings for each image) that the operator can choose to use as suggested, or use as a starting point for various customizations.

At block 670, when the operator has specified a container job, the element of the machine vision system designated to perform the container job (e.g., a designated camera, a controller, etc.) performs an analysis based on the individual outputs determined per block 660. For example, after N jobs performed on N images from N cameras have rendered N outputs per N instances of block 660, an overview output for the collective set of N images is rendered per block 670.

At block 680, the controller analyzes the output of the virtual device. For example, by receiving the individual outputs of N cameras into a shared canvas, the virtual device provides a single pass/fail indication via a linked quality assurance device. In various embodiments, the indication for pass/fail of the object observed by the virtual device is a job with several individual pass/fail criteria that can trigger a passing or failing analysis of the object. For example, the various criteria may include one or more of: optical character recognition, barcode recognition, feature presence, and alignment verification between two identified features of the object.

In various embodiments, as part of generating and displaying the proposal per block 630 and block 640, the machine learning model may propose, or the operator may select, one or more quality assurance devices (e.g., an indicator 190, such as a light pole, speaker or other sound producing device, or a pass/fail sorting mechanism (e.g., an arm, door, chute, stamping/labeling system, etc.) in the computer vision system) that are associated with the analysis outcomes from the various jobs. The computing devices performing the analyses may record the outcomes (and images) to a database to save the results for review or future analysis, and selectively activate the associated quality assurance devices as part of block 660, block 670, and block 680 to alert operators to non-conformities, redirect product in a process flow, halt production, or various combinations thereof.

In various embodiments, the analyses performed in block 660, block 670, and block 680 can be performed on the respective cameras, a controller or other centralized computing device, or combination thereof. In embodiments that use the computing devices included in the camera to perform the analysis of block 670, the machine learning model may identify one such computing device to use as a centralized computing device to perform the contain job analyses, such as the camera that captures the latest image among used in the container job is identified by the machine learning model to perform the container job in addition to the individual job for analyzing the corresponding image. For example, if four cameras each run identical instances of wheel inspection job on different wheels of a vehicle, one camera may be designated to receive the individual outcomes from the other cameras (in addition to the local outcome determination) and make an overall analysis outcome determination for whether the vehicle includes four wheels that all pass inspection.

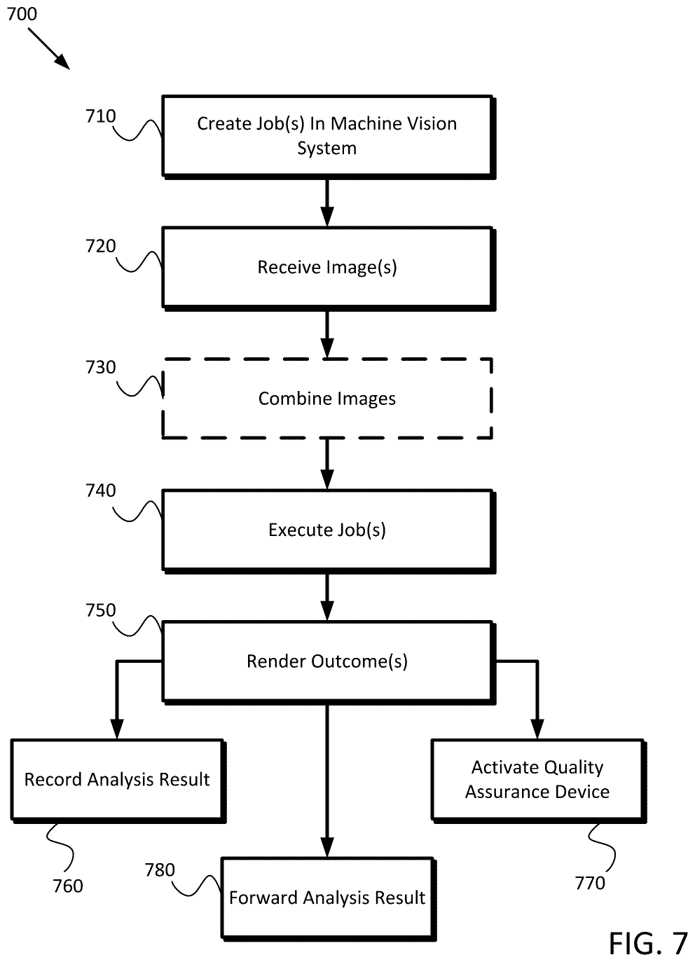

FIG. 7 is a flowchart of an example method 700 for executing a job on an image in machine vision systems, according to embodiments of the present disclosure. Method 700 begins with block 710, where one or more jobs are created for analysis of images captured by the cameras of the machine vision system, such as discussed in greater detail in regard to FIG. 6. In various embodiments, one or more individual jobs may be created to analyze the individual images captured by corresponding cameras, a shared job may be created to analyze images captured by several cameras acting as virtual device using a shared canvas to combine the images for analysis according a single job, or a container job may be created to provide an overview analysis of several individual images captured by corresponding cameras.

At block 720, the cameras capture the respective images. In various aspects, the cameras may be triggered to capture these images according to various trigger conditions (e.g., timing based on the activation of other devices, light curtain activation, weight sensor activation, presence button actuation, manual control, etc.). In various embodiments, these images may be stored locally by the cameras for processing on the camera that captured the image, or may be passed to another camera, a controller for the machine visions system, or another centralized computing device to process the images for analysis.

At block 730, when the created job includes a shared job, the captured images are combined in a shared canvas for shared analysis. Method 700 may omit block 730 when the job(s) created per block 710 do not include a shared job.

At block 740, the machine vision system executes the jobs on the images. In various embodiments, the cameras may locally execute the jobs on the images captured by those cameras or a central computing device may execute the jobs using the images captured by (other) cameras or the analysis outputs received from the (other) cameras.

At block 750, the machine vision system via the camera, controller, or other computing device that executes the job per block 740 renders an outcome. In various embodiments, each of the tools included in a job may render associated outcomes (e.g., a presence tool may indicate a positive/negative indication for presence of a feature, a barcode scanner tool may output an alphanumeric value encoded by a barcode, a counting tool may output a number of a given feature identified, an object recognition tool may output an identify of an object selected from a library or list, etc.). Method 700 may proceed from block 750 to one or more of block 760, block 770, and block 780.

At block 760, the machine vision system records the analysis result. In various embodiments, the image, the outcome(s) rendered per block 750, or both are recorded to a database for later analysis.

At block 770, the element of the machine vision that executed the job activates a quality assurance device associated with the job based on the analysis outcome rendered per block 750. For example, on receiving a failing result, a camera may activate a red light on a light pole or on receiving a passing result the camera may activate a green light on the light pole. In another example, on receiving a failing result, a controller may activate a motor or actuator associated with a chute or door to direct failing product to a reject bin or rework station.

At block 780, the element of the machine vision that executed the job forwards the analysis result to another element of the machine vision system for further analysis (e.g., as part of a container job) or for storage on an external device, a cloud based service, or a centralized computing device.

FIG. 8 illustrates an example computing device 800, such as may be used in a machine vision system 110 according to embodiments of the present disclosure. The computing device 800 includes a processor 810, such as a central processing unit (CPU) and/or graphics processing unit (GPU), application-specific integrated circuit (ASIC), or the like, communicatively coupled with a non-transitory computer-readable storage medium such as a memory 820, e.g., a combination of volatile memory elements (e.g., random access memory (RAM)) and non-volatile memory elements (e.g., flash memory or the like). The memory 820 stores a plurality of computer-readable instructions in the form of applications, including an operating system 822, one or more programs 824 by which the computing device 800 is instructed to perform various operations when the instructions are executed by the processor 810, and one or more machine learning models 826 used by the programs 824, as described herein.

The computing device 800 also includes a communications interface 830, enabling the computing device 800 to establish connections with other computing devices 800 over various wired and wireless networks. The communications interface 860 can therefore include any suitable combination of transceivers, antenna elements, and corresponding control hardware enabling communications across a network. The computing device 800 can include further components (not shown), including output devices such as a display, a speaker, and the like, as well as input devices such as a keypad, a touch screen, a microphone, and the like.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 8%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
identifying a first camera and a second camera of a plurality of cameras associated with a machine vision system, wherein the first camera and the second camera are identified based on a first activation time for the first camera being connected to the machine vision system being within a threshold interval from a second activation time for the second camera being connected to the machine vision system;
displaying, in a graphical user interface, a proposal to operate the first camera and the second camera as a virtual device in performing a job in the machine vision system using the first camera and the second camera; and
in response to receiving confirmation of the proposal:
creating the job in the machine vision system;
receiving a first analysis image from the first camera and a second analysis image from the second camera;
combining the first analysis image and the second analysis image into a combined image;
executing the job on the combined image; and
rendering an outcome based on an analysis of the combined image according to the job.

2. The method of claim 1, wherein the first camera and the second camera are identified further based on:
identifying an overlap in a first image produced by the first camera with a second image produced by the second camera.

3. The method of claim 1, wherein the first camera and the second camera are identified further based on:
activating a light source; and
observing a threshold change in contrast or brightness in a first image produced by the first camera and the threshold change in contrast or brightness in a second image produced by the second camera while the light source is activated compared to when the light source is inactive.

4. The method of claim 1, wherein the first camera and the second camera are identified further based on:
the first camera being connected to a first port of a computer vision system at a first address within a threshold value of a second address of a second port of the machine vision system that the second camera is connected to.

5. The method of claim 1, wherein the first camera is grouped into a second virtual device with a third camera that is not grouped in the virtual device with the second camera.

6. The method of claim 1, wherein a first output of the first camera and a second output of the second camera are saved to a shared canvas.

7. The method of claim 1, wherein a machine learning model identifies the first camera and the second camera from the plurality of cameras.

8. The method of claim 1, wherein at least one camera of the plurality of cameras is an emulated camera.

9. A method, comprising:
receiving a plurality of outputs from a corresponding plurality of cameras associated with a machine vision system;
analyzing a combined output of the plurality of outputs;
identifying a first subset of cameras from the plurality of cameras that provided outputs in the plurality of outputs that include images of a specified portion of an object at or above a specified confidence interval for a machine learning model to determine whether the specified portion satisfies a pass/fail criterion;
identifying a second subset of cameras from the first subset of cameras that provide overlapping coverage of the specified portion with one another;
identifying a reduced number of cameras from the second subset as a third subset of cameras that provide total coverage of the specified portion;
outputting, to a user interface, the third subset of cameras as a virtual device for the machine vision system to use a combined output from;
in response to receiving confirmation of the virtual device, generating a job for the virtual device to perform in analyzing an object according to a set of criteria; and
recording an analysis result of the virtual device for the job.

10. The method of claim 9, further comprising:
activating a quality assurance device associated with the virtual device according to the analysis result of the combined output received from the virtual device.

11. The method of claim 9, wherein the plurality of cameras includes a plurality of emulated cameras for which a single physical camera provides multiple associated outputs to emulate.

12. The method of claim 9, wherein the specified confidence interval includes an evaluation that at least a threshold number of pixels captured by a first camera in a first image of an object match a second image of the object captured by a second camera.

13. The method of claim 9, wherein the pass/fail criterion includes at least one of:
optical character recognition;
barcode recognition;
feature presence; and
alignment verification between two identified features of the object.

14. A method, comprising:
identifying a first camera having a first field of view including a first portion of an object under inspection by a machine vision system and a second camera having a second field of view including a second portion of the object under inspection by the machine vision system, wherein the second portion is not included in the first field of view and the first portion is not included in the second field of view;
combining a first output of the first camera with a second output of the second camera as a combined output from a virtual device;
identifying a quality assurance device for the machine vision system to use in association with a job defined for the virtual device; and
activating the quality assurance device according to an analysis of the first portion and the second portion visible in the combined output received from the virtual device according to the job.

15. The method of claim 14, wherein identifying the first camera and the second camera includes:
reducing a plurality of cameras associated with the machine vision system to a first subset of nearby cameras; and
analyzing images for related FOVs.

16. The method of claim 15, wherein related FOVs see threshold changes in lighting conditions when light source cycled between an active state and an inactive state.

17. The method of claim 15, wherein related FOVs include a shared element of the object in each output.

18. The method of claim 14, wherein the combined output is saved in a shared canvas that the first camera and the second camera both write to.

19. The method of claim 14, wherein the first camera and the second camera capture images of the object at non-overlapping times.

20. The method of claim 14, wherein a machine learning model identifies the first camera and the second camera from a plurality of cameras available to the machine vision system including additional cameras to the first camera and the second camera.

21. A method, comprising:
identifying a first camera and a second camera of a plurality of cameras associated with a machine vision system, wherein the first camera and the second camera are identified based on at least one of:
a first activation time for the first camera being connected to the machine vision system being within a threshold interval from a second activation time for the second camera being connected to the machine vision system;
identifying an overlap in a first image produced by the first camera with a second image produced by the second camera;
activating a light source, and observing a threshold change in contrast or brightness in a first image produced by the first camera and the threshold change in contrast or brightness in a second image produced by the second camera while the light source is activated compared to when the light source is inactive; or
the first camera being connected to a first port of a computer vision system at a first address within a threshold value of a second address of a second port of the machine vision system that the second camera is connected to;
displaying, in a graphical user interface, a proposal to operate the first camera and the second camera as a virtual device in performing a job in the machine vision system using the first camera and the second camera; and
in response to receiving confirmation of the proposal:
creating the job in the machine vision system;
receiving a first analysis image from the first camera and a second analysis image from the second camera;
combining the first analysis image and the second analysis image into a combined image;
executing the job on the combined image; and
rendering an outcome based on an analysis of the combined image according to the job.

22-40. (canceled)
